(19) United States
(12) Patent Application Publication
(10) Pub. No.: US 2014/0335486 A1
(43) Pub. Date: Nov. 13, 2014

(54) Comprehensive, Structured And Systematic Attention Training Tutoring Program

(71) Applicant: Naomi Honigsberg, Newton, MA (US)

(72) Inventor: Naomi Honigsberg, Newton, MA (US)

(21) Appl. No.: 14/269,444

(22) Filed: May 5, 2014

Related U.S. Application Data
(60) Provisional application No. 61/820,949, filed on May 8, 2013.

(51) Int. Cl. G09B 19/00

(52) U.S. Cl. CPC G09B 19/00
USPC 434/236

(57) ABSTRACT

A method, apparatus and computer program product for attention training and tutoring is presented. Attention training and tutoring is provided which includes providing at least two of the group including behavioral therapy, parent training, development of routines to support attention, on-going feedback during the sessions, mindfulness and/or biofeedback, self-awareness of student's focus, and gradual mastery and independence towards tasks. The attention training and tutoring program includes structured lessons delineated in a protocol, research-based approaches, systematic lesson plan, systematic training, formal questionnaires, and web-based data tracking and review in order to provide an enhanced outcome. The attention training and tutoring includes providing neurofeedback training, the neurofeedback training aiding a user in learning to focus and to maintain focus; and providing relaxation and biofeedback, the relaxation and biofeedback aiding a user in learning to relax via calm breathing or biofeedback.

### CROSS REFERENCE TO RELATED APPLICATIONS

The present application claims the benefit of U.S. Provisional Patent Application No. 61/820,949, filed on May 8, 2013, which is incorporated herein by reference in its entirety

### BACKGROUND

Attention deficit-hyperactivity disorder (ADHD) also known as hyperkinetic disorder (HKD) is a mental disorder or neurobehavioral disorder characterized by either significant difficulties of inattention or hyperactivity and impulsiveness or a combination of the two. According to the Diagnostic and Statistical Manual of Mental Disorders (DSM-V), symptoms emerge before twelve years of age. There are three presentations of the disorder which consist of it being predominantly inattentive (ADHD-PI or ADHD-I), predominately hyperactive-impulsive (ADHD-HI or ADHD-H), or the two combined (ADHD-C). Often people refer to ADHD-PI as “attention deficit disorder” (ADD). ADHD impacts school-aged children and results in restlessness, acting impulsively, and lack of focus which impairs their ability to learn properly.

ADHD is the most commonly studied and diagnosed neurodevelopmental disorder in children, affecting about 3 to 5 percent of children globally and is diagnosed in about 2 to 16 percent of school-aged children. It is a chronic disorder with 30 to 50 percent of those individuals diagnosed in childhood continuing to have symptoms into adulthood. Adolescents and adults with ADHD tend to develop coping mechanisms to compensate for some or all of their impairments. It is estimated that between two and five percent of adults live with ADHD. ADHD is diagnosed two to four times more frequently in boys than in girls. Its symptoms can be difficult to differentiate from other disorders, increasing the likelihood that the diagnosis of ADHD will be missed. In addition, most clinicians have not received formal training in the assessment and treatment of ADHD, in particular in adult patients.

### SUMMARY

ADHD management recommendations from the American Academy of Pediatrics (AAP 2011) include medication therapy and/or behavior therapy (which might also include lifestyle changes and counseling). ADHD medications can also be given first line, before behavioral approaches, other than in preschoolers where the behavioral approach should be used before medication.

ADHD and its diagnosis and treatment have been considered controversial since the 1970s. The controversies have involved clinicians, teachers, policymakers, parents and the media. Topics include ADHD's causes, and the use of stimulant medications in its treatment. Most healthcare providers accept ADHD as a genuine disorder—debate in the scientific community centers mainly around divergent neurobiological concepts, how it is diagnosed and treated.

Embodiments of the invention provide a comprehensive, structured and systematic attention training and tutoring program that includes within one lesson multiple research-based non-pharmacological attention training approaches including in each lesson behavioral components and computer attention training.

In a particular embodiment of a method for providing an attention training and tutoring program the method includes providing attention training and tutoring. The method further includes providing at least two of the group including behavioral therapy, parent training, development of routines to support attention, on-going feedback during the sessions, mindfulness and/or biofeedback, self-awareness of student's focus, and gradual mastery and independence towards tasks.

Other embodiments include a computer readable medium having computer readable code thereon for providing an attention training and tutoring program. The compute readable medium includes instructions for providing computer attention training. The computer readable medium further includes instructions for providing at least two of the group including behavioral therapy, parent training, development of routines to support attention, on-going feedback during the sessions, mindfulness, relaxation breathing and/or biofeedback, self-awareness of student's focus, and gradual mastery and independence towards tasks.

Still other embodiments include a computerized device, configured to process all the method operations disclosed herein as embodiments of the invention. In such embodiments, the computerized device includes a memory system, a processor, communications interface in an interconnection mechanism connecting these components. The memory system is encoded with a process that provides attention training and tutoring as explained herein that when performed (e.g. when executing) on the processor, operates as explained herein within the computerized device to perform all of the method embodiments and operations explained herein as embodiments of the invention. Thus any computerized device that performs or is programmed to perform the processing explained herein is an embodiment of the invention.

Other arrangements of embodiments of the invention that are disclosed herein include software programs to perform the method embodiment steps and operations summarized above and disclosed in detail below. More particularly, a computer program product is one embodiment that has a computer-readable medium including computer program logic encoded thereon that when performed in a computerized device provides associated operations providing an attribute level change history as explained herein. The computer program logic, when executed on at least one processor with a computing system, causes the processor to perform the operations (e.g., the methods) indicated herein as embodiments of the invention. Such arrangements of the invention are typically provided as software, code and/or other data structures arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC) or as downloadable software images in one or more modules, shared libraries, etc. The software or firmware or other such configurations can be installed onto a computerized device to cause one or more processors in the computerized device to perform the techniques explained herein as embodiments of the invention. Software processes that operate in a collection of computerized devices, such as in a group of data communications devices or other entities can also provide the system of the invention. The system of the invention can be distributed between many software processes on several data communications devices, or all processes could run on a small set of dedicated computers, or on one computer alone.

It is to be understood that the embodiments of the invention can be embodied strictly as a software program, as software and hardware, or as hardware and/or circuitry alone, such as within a data communications device.

Note that each of the different features, techniques, configurations, etc. discussed in this disclosure can be executed independently or in combination. Accordingly, the present invention can be embodied and viewed in many different ways. Also, note that this summary section herein does not specify every embodiment and/or incrementally novel aspect of the present disclosure or claimed invention. Instead, this summary only provides a preliminary discussion of different embodiments and corresponding points of novelty over conventional techniques. For additional details, elements, and/or possible perspectives (permutations) of the invention, the reader is directed to the Detailed Description section and corresponding figures of the present disclosure as further discussed below. All examples and features mentioned below can be combined in any technically possible way.

### BRIEF DESCRIPTION OF THE DRAWINGS

The foregoing will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a block diagram of the presently disclosed comprehensive, structured and systematic attention training and tutoring program in accordance with embodiments of the invention.

FIGS. 2A and 2B comprise a flow diagram of a particular embodiment of an attention training and tutoring program in accordance with embodiments of the invention.

FIG. 3 illustrates an example computer system architecture for a computer system that provides an attention training and tutoring program in accordance with embodiments of the invention.

### DETAILED DESCRIPTION

The embodiments set forth below represent the necessary information to enable those skilled in the art to practice the invention and illustrate the best mode of practicing embodiments of the invention. Upon reading the following description in light of the accompanying figures, those skilled in the art will understand the concepts of the invention and recognize applications of these concepts not particularly addressed herein. It should be understood that these concepts and applications fall within the scope of the disclosure and the accompanying claims.

The preferred embodiment of the invention will now be described with reference to the accompanying drawings. The invention may, however, be embodied in many different forms and should not be construed as limited to the embodiment set forth herein; rather, this embodiment is provided so that this disclosure will be thorough and complete, and will fully convey the scope of the invention to those skilled in the art. The terminology used in the detailed description of the particular embodiment illustrated in the accompanying drawings is not intended to be limiting of the invention. In the drawings, like numbers refer to like elements.

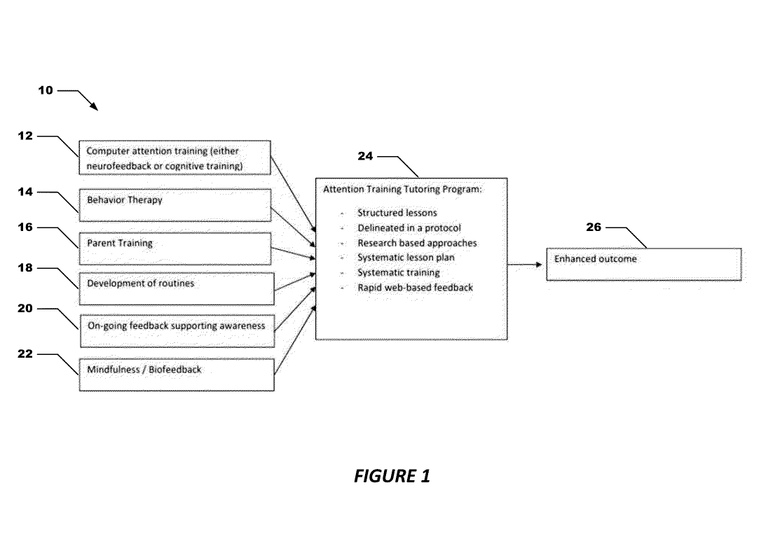

Referring to FIG. 1, a block diagram representing the presently described comprehensive, structured and systematic attention training and tutoring program is shown. The program 10 is unique, novel and has increased efficacy because it contains not only one research-based approach shown to enhance attention, but multiple approaches structured into a unique educational attention training lesson, and all lessons include computer attention training 12 (either neurofeedback or cognitive training) The attention training components brought together in these attention training and tutoring lessons will all include computer attention training, either though neurofeedback or computer cognitive training.

Other areas that are included in most tutoring lessons are as follows: behavioral therapy 14, parent training 16, development of routines to support attention 18, on-going feedback during the sessions 20, and mindfulness, relaxation and/or biofeedback 22. Other areas may also include self-awareness of student's focus and gradual mastery and independence towards tasks. Traditionally, until the development of this tutoring attention training program, each of these elements have typically been offered in isolation by a therapist, some therapists might use two of these approaches, no therapist uses all of these including computer attention training, and certainly not in the systematic way described below. The attention training and tutoring program 24 includes structured lessons designed to provide an enhanced outcome 26.

It is unique to have attention training lessons combine both computer attention with other approaches to enhance efficacy. The program is unique because it follows a specific protocol or curricula where elements of each lesson are carefully delineated. The carefully prepared protocol takes into consideration research-based described deficiencies of students with attention or organization/executive function issues and ADHD, prioritizing elements that will most support these students towards success. This program is unique because tutors receive a systematic training to deliver these comprehensive approaches through lessons in the described systematic way. These attention training and tutoring lessons are appropriate for all students with attention issues, and do not exclude students with other issues such as anxiety or autism. The attention training and tutoring lessons are adapted to different developmental age groups, including preschoolers, elementary students, middle school students, high school students, college/and adults, and those above 50 years of age.

Feedback and progress are monitored closely through a web-based system and through systematic regular feedback as described by the protocol. The attention training and tutoring program includes on-going feedback (including but not limited to formal questionnaires), and regular recap meetings with parents. The families get a written check-in report at various stages of the program, the reports serving to delineate what the student has learned and establish goals going forward. A post intervention check-in may also be provided after the end of the program to insure that the family is following through with recommendations. Technology will enable the tutor to communicate the lesson comments to the supervisor and to receive suggestions back. Students will be required to do homework as part of the program. Students and parents will be able to view learning videos via the web based system. The program offers refresher sessions that might benefit the student after a few years, as the student reaches another developmental stage such as entering high school.

The presently described attention training and tutoring program serves to help a child succeed in school. By pulling together training in neurofeedback, executive functioning and organization skills, and relaxation and biofeedback, the child receives everything they need. Tutors come to the child's home twice a week to complete a 30 lesson program, aimed at increasing attention and improving study habits. Each lesson includes the following:

1. Neurofeedback training, used to learn to increase focus and maintain focus

2. Executive functioning and organization skills training, used to train scheduling, time management, and organization skills.

3. Relaxation and biofeedback, used to teach relaxation through calm breathing or biofeedback.

The goal of the attention training and tutoring program is to support children and adolescents with ADHD or attention difficulties, and their families to improve their attention, increase their self-awareness, and enhance their lives. This program trains their brain through neurofeedback, executive functioning and organization skills training, and relaxation/biofeedback.

Each child or adolescent is different in many ways. Yet, children with ADHD and attention difficulties tend to have difficulty getting started, maintaining attention, staying organized, managing time, and often calming down.

In order to develop healthy attention habits it is critical for students and their families to understand how the brain of children or adolescents with ADHD or attention difficulties is different. As a part of the program, families are taught about the frontal brain. This is the part of the brain that takes care of focusing and maintaining focus. Additionally, the frontal brain is in charge of executive functioning tasks such as prioritization, time management, organization, planning out work, and making sure everything gets done on time.

The program also explains current research to families on how the brains of people with ADHD benefit from regular sleep, physical activity, and structured routine.

ADHD and attention difficulties can affect life at school. When the kindergarten teacher calls out to the class to gather up for circle time, children come and sit around her. Then the teacher picks up a three-foot-tall ‘Gingerbread Man’ book and starts to read. At that time, typical children naturally begin to pay attention and listen, as their fontal brain becomes activated with beta waves (attention brainwaves) and theta waves (drowsiness waves) decrease. This happens like an automatic switch, just because the teacher has started to read. For children with ADHD this is not the case. Their frontal brains, specifically the beta waves (attention brainwaves), are not so active and they have an excess of theta waves, so their brains don't switch on as easily to focus. For students with ADHD, switching their brain on is not automatic, it takes a lot of work and effort.

A few years later, as the middle school history teacher explains the American Revolution, what goes on in the classroom? Typical children follow what the teacher is saying so that they can gather the information required for their long-term assignment and remain focused on what the teacher is saying. In addition, they can do this for as long as the teacher is giving information because teachers adapt the length of explanations to the typical student. It is difficult for a student with ADHD to maintain high beta waves (attention brainwaves) over time, so maintaining focus becomes difficult and s/he will become easily distracted and tired.

This example also applies to listening to the teacher in high school or following a lecture in college. As students progress through the grades, expectations increase in all areas, including attention span, organization, and time management. Students with attention difficulties and ADHD will also continue to mature in those areas, yet discrepancies usually persist between them and typical students. This can lead to continued challenges and frustration.

Brain activity in the form of brainwaves can be recorded by an Electro-Encephalic Graph (EEG) sensor. An EEG sensor only records activity from the brain and does not give out any impulse towards the brain. Research on EEG patterns has shown that different brainwave patterns represent different states of alertness. People with ADHD typically have a different brainwave pattern in an area of the brain called the frontal brain, an area in the front of the brain behind the forehead.

Research using brain scans has shown that the brains of children and adolescents with ADHD are different. Specifically, the frontal brains are different. The frontal brain takes care of tasks like switching the brain on in order to pay attention, maintaining attention, and executive functioning. Executive functioning is often challenging in children and adolescents with attention difficulties and ADHD. It consists of getting tasks finished, time management, getting organized, and prioritizing. As students reach higher grades these skills are increasingly critical to complete academic tasks.

In children and adolescents with ADHD, careless mistakes are not because of laziness, and the impulsivity of snatching a doll away from another child is not purposefully mean. Children with ADHD don't “do it on purpose” when they make careless mistakes on tests, forget their homework, and miss the school bus.

Scientists know that different brainwaves represent different states of alertness of the brain. Some brainwaves are most prevalent when asleep, others when drowsy, and others while focusing. Scientists have found that people with ADHD have alterations in their brainwave patterns compared to people without ADHD. People with ADHD typically have an increase in drowsy waves (also known as theta waves) and a decrease in attention waves (also known as beta waves) in the frontal brain, which is precisely the attention and organization part of the brain. This makes it very difficult to pay attention, remain focused, and get work done.

The use of neurofeedback increases attention and executive functioning. There are different types of neurofeedback. This attention training and tutoring program is an educational approach that uses neurofeedback to support an increase in beta (attention) brainwaves, and suppress the theta (drowsiness) brainwaves.

A neurofeedback sensor, or an EEG sensor, picks up beta (attention) brainwaves and theta (drowsy) brainwaves. As the student looks at a screen he or she receives visual and auditory feedback on how he or she is paying attention to an exercise by following an animated figure or a graph. Over the 30 lessons, this practice aims ease initiation of attention (or switch brain on), maintain attention (or keep the brain on), and strengthen executive functioning.

Neurofeedback works through the thoroughly researched principal of brain plasticity. Brain plasticity is the ability of the brain to learn and alter its neural networks, in response to the environment. During the lessons, the neurofeedback exercises train this learning. As students learn how to increase their beta waves and decrease their theta waves, they are reshaping their brain and learning through this phenomenon of brain plasticity.

The program recommends starting to train organization and work skills as early as possible. Typical students will be able to follow expectations that the teacher will have, because teachers base their expectations on the general classroom. For students with ADHD and attention difficulties being organized and focused does not come automatically. In fact students with attention issues and ADHD have to put in a lot of effort to try to keep up with school expectations. For instance, students with ADHD will try very hard to use their school assignment notebook, but it will not seem to help them out very much. The fact is that when students with ADHD are trying to figure out how to get tasks done alone, without a systematic tutoring curriculum, it can be very frustrating and unsuccessful. Tasks become overwhelming and students don't have the tools necessary to complete the work. It is important that students have the tools and support to develop independence.

It is important to train organizational skills. Often organizational challenges are not apparent in elementary school because most elementary school teachers do not have extensive expectations in regards to organization, and they tend to breakdown tasks. However towards 4th and 5th grade, and as soon as middle school creeps in, organization issues usually become more apparent and create frustration for students who have a hard time tracking different assignments from different teachers. Some teachers want homework placed in their classroom box, others want it sent via email, and others via online websites. Some teachers write homework on the white board, while other teachers post all the homework and materials on their websites and expect their students to visit their website daily after school.

The attention training and tutoring program uses a systematic approach. This program teaches students executive functioning and organization skills though a systematic Attention Tutoring curriculum broken down into the 30 lessons. This is an educational program presented in a stepwise manner throughout the lessons, with related homework.

Here are some of the executive functioning and organization skills that tutors work on with the students: identifying typical challenging situations for each individual child, understanding how the brain works, setting up a neat and helpful workstation, learning to schedule homework, getting homework and tasks done, avoiding distractions, learning how to pace work, understanding how to change their home and school environment, and working towards independence. These skills are taught in a stepwise manner with homework.

During the lessons students learn the importance of a calm body in order to focus. Research shows that a relaxed body prepares the brain to pay attention. In addition, children, adolescents and adults with ADHD are often anxious. They tend to worry a lot, for instance about getting their work done on time, remembering to give it in, meeting deadlines, or that they might forget something important—as they have done in the past. Of course learning to develop and follow a schedule helps decrease the worry of meeting long-term assignments. However, learning to relax increases comfort and quality of life.

The great news is that relaxation techniques can be learned and mastered easily. Students learn relaxation techniques such as calm breathing and biofeedback.

During the lessons, students practice short relaxation either through relaxation breathing techniques or biofeedback. Both of these methods successfully slow down the breathing within a few minutes. This leads to a well-researched physiological reaction called the “relaxation response”, where the sympathetic nervous system activity (fight or flight) decreases and the parasympathetic nervous system activity (rest and digest) increases, leading to a decrease in heart rate and blood pressure. The body becomes calmer, more comfortable, and ready to focus.

At each lesson, tutors work with students using biofeedback. The biofeedback apparatus measures and shows the student's heart rate on a screen. When a person breathes, his or her heart rate naturally increases when breathing in, and decreases when breathing out. The biofeedback device tracks the difference in heart rate between breathing in and breathing out. This is also called heart rate variability (HRV), which is depicted on the screen by a curve. Essentially, the curve shows the students' respirations, and prompts them to deepen and slow respirations. When this happens, the sympathetic nervous system activity slows down, and the parasympathetic nervous system kicks in. This makes one feel relaxed.

A relaxed body prepares the brain to switch on and think. Students find that being comfortable is an immediate relief and also gives them a sense of control.

The goal for the attention training and tutoring program is to teach skills and increase awareness in students. As students recognize the benefits of relaxation, they are encouraged to practice their learned skills throughout the day, during challenging transitions, at home or at school.

Another program is geared to college students and adults. This program is designed to increase the attention span of the college students and adults so that they can pay better attention during lectures, in meetings, at work and other daily activities. There are 20 lessons. Included in each lesson is:

1. Neurofeedback training, used to learn to increase focus and maintain focus

2. Executive functioning and organization skills training, used to train scheduling, time management, and organization skills.

3. Relaxation and biofeedback, used to teach relaxation through calm breathing or biofeedback.

The goal of this program is to support college students and adults with attention or organization/executive function difficulties or ADHD to train their brains through neurofeedback and relaxation/biofeedback. This program aims to enhance their attention, their self-awareness and their lives.

This program is a systematic adult educational program including several lessons, which are delivered by a certified tutor at home twice a week.

The program teaches about differences in the frontal brain, which is the part of the brain that takes care of focusing, maintaining focus, prioritizing, time management, organization, and other attention and executive functioning tasks, such as planning out work, getting organized, and making sure everything gets done on time. The program also reviews research on how the brain of people with ADHD benefit from regular sleep, physical activity, and structured routine.

ADHD and attention/organization difficulties can affect life at work. The fact that adults also have attention or organization/executive function difficulties and ADHD and that this can significantly affect their work life is greatly underestimated. Most research in the area of adult ADHD is also skewed because it uses poorly adapted childhood criteria to evaluate and diagnose adults, whereas adults of course have other responsibilities and life styles.

Yet, adults that were diagnosed as children or have diagnosed themselves with these issues, know that their daily functioning is impacted. Many of them are looking for ways to support their lives without resorting to medication.

Adults with attention or organization/executive function difficulties or ADHD may have difficulties that affect how they get things done and how they feel about themselves. They experience challenges that might include: difficulty staying on task long enough to get things done, becoming distracted easily when there is noise or something else going on, tendency to procrastinate and not get things done on time, overlooking details, zoning out (especially when someone speaks for a lengthy amount of time), over-committing while underestimating the amount of time tasks take, impulsivity such as responding to emails or texts without thinking about the effect of the response, having multiple ideas at the same time and not expressing them in a clear manner, anxiety or feelings of being overwhelmed, and double checking.

College students will have difficulty in maintaining focus during a lecture. They might be interested or even hyper-focused on one of their classes, letting other classes slip behind. Procrastinating can also take a toll because most college assignments are problem sets, long-term projects, group work that has to be arranged, and exams that have to be prepared in advance. College for students with attention or organization/executive function difficulties or ADHD can lead to continued frustration.

Brain activity in the form of brainwaves can be recorded by an Electro-Encephalic Graph (EEG) sensor. An EEG sensor only records activity from the brain and does not give out any impulse towards the brain. Research on EEG patterns has shown that different brainwave patterns represent different states of alertness. People with ADHD typically have a different brainwave pattern in the frontal brain, an area in the front of the brain behind the forehead.

The frontal brain takes care of tasks like switching the brain on in order to pay attention, maintaining attention, and executive functioning. Executive functioning is often challenging in those with attention difficulties and ADHD. It consists of getting tasks finished, time management, getting organized, and prioritizing. Research using brain scans has also been important in showing that the brains of adults with ADHD are different.

Different brainwaves represent different states of alertness of the brain. Some brainwaves are most prevalent when asleep, others when drowsy and others during focus. Scientists have found that people with ADHD have alterations in their brainwave patterns compared to people without ADHD. People with ADHD typically have an increase in drowsy waves (also known as theta waves) and a decrease in attention waves (also known as beta waves) in the frontal brain, which is precisely the attention and organization part of the brain. This makes it very difficult to pay attention, remain focused, and get work done.

Another program is designed for all adults 50+ and aims to maintain the adult's attention and cognition. The neurofeedback trains attention stamina and the computer-based cognitive exercises target executive functions including memory and speed. Relaxation training through biofeedback is used to increase overall well-being. Lessons are given twice a week in an intensive program and thereafter participants may choose to continue with once a week lessons. Navigating the computer exercises is easy; no prior computer skills are required. Included in each lesson:

Lessons include:

Neurofeedback, to learn to increase focus and maintain focus.

Exercises (computer-based cognitive exercises), to strengthen executive functions including speed and memory.

Relaxation/Biofeedback techniques, to teach relaxation through calm breathing or biofeedback to support quality of life and sleep.

This program is an adult educational program of 50-minute lessons, which are delivered by a certified tutor.

Cutting-edge brain research has taught us very important points that led Dr. Steiner to develop this program specifically for adults 50+. First, the brain is “plastic,” which means that it has the ability to change and learn. More recent research has shown that brain plasticity remains throughout life. Second, using the brain protects against cognitive decline. This program has been designed to keep the brain focused and actively training. Lastly, keeping the brain fit is important and can benefit all adults not only those who might be concerned about cognitive decline.

This program reviews research with participants on how the brain also benefits from regular exercise, healthy diet and sleep.

Brain activity in the form of brainwaves can be recorded by an Electro-Encephalic Graph (EEG) sensor. An EEG sensor only records activity from the brain and does not give out any impulse towards the brain. The frontal brain takes care of tasks like switching the brain on in order to pay attention, maintaining attention, and executive functioning. Executive functioning consists of getting tasks finished, time management, getting organized, and prioritizing. Different brainwaves represent different states of alertness of the brain. Some brainwaves are most prevalent when asleep, others when drowsy and others during focus.

Neurofeedback can increase attention and executive functioning. There are different types of neurofeedback. This program is an adult educational approach that aims to support an increase in beta (attention) brainwaves, and suppress the theta (drowsiness) brainwaves. A neurofeedback sensor, or an EEG sensor, picks up beta (attention) brainwaves and theta (drowsy) brainwaves. As the participant looks at a screen he or she receives feedback on how he or she is paying attention to an exercise by following an animated figure or a graph. Over the lessons, this practice aims to helps switch on the brain, maintain attention and strengthen executive functioning.

Neurofeedback works through the thoroughly researched principal of brain plasticity. Brain plasticity is the ability of the brain to learn and alter its neural networks, in response to the environment. During the lessons, the neurofeedback exercises train this learning. As the participant learns how to increase their beta waves and decrease their theta waves, they are reshaping their brain and learning through this phenomenon of brain plasticity.

The program uses a series of computer-based cognitive exercises, which train different aspects of cognition and thinking, including executive functions such as memory and speed. Computer cognitive exercises have been shown to help adults 50+ maintain these skills and even improve on the targeted skills trained. Navigating the computer exercises is easy; no prior computer skills are required. In addition, the tutor is present to support the easy flow of the exercises and assure that all participants progress successfully.

The tutor also works with participants to personalize specific target areas to practice. For instance, a participant who has arthritis of the hand might want to avoid a specific brain exercise that practices visual motor skills, such as integrating what is seen on the computer screen and quick usage of the mouse. On the other hand, another participant might specifically be interested in targeting these exercises to train fast reactions. It is possible to train cognitive areas through a diversity of exercises, as there are many overlapping computer cognitive exercises.

During this program, participants learn the importance of a calm body for their quality of life, sleep and to promote focus. Research shows that a relaxed body prepares the brain to pay attention. The great news is that relaxation techniques can be learned and mastered easily. The program teaches relaxation techniques such as calm breathing and biofeedback.

During the lessons, participants practice short relaxation either through relaxation breathing techniques or biofeedback. Both of these methods successfully slow down breathing within a couple of minutes. This leads to a well-researched physiological reaction called the “relaxation response”, where the sympathetic nervous system activity decreases and the parasympathetic activity increases, leading to a decrease in heart rate and blood pressure. The body becomes calmer, more comfortable, and ready to focus.

At each lesson, tutors work with participants using biofeedback. The biofeedback apparatus measures heart rate and displays it on a screen. Without being aware, there is a physiological, or natural, heart rate increase when breathing in and a decrease when breathing out. The biofeedback device tracks the difference in heart rate between breathing in and breathing out. This is also called heart rate variability (HRV), which is depicted on the screen by a curve. Essentially, the curve shows their respirations, and prompts them to deepen and slow respirations. When this happens, the sympathetic nervous system activity slows down, and the parasympathetic nervous system kicks in. This makes one feel relaxed.

Participants find that being comfortable is an immediate relief and also gives a sense of control. The goal of the attention training and tutoring program is to teach skills and increase awareness in participants. Practice of learned skills is encouraged throughout the day during challenging tasks, or times at home, at work, or when volunteering.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

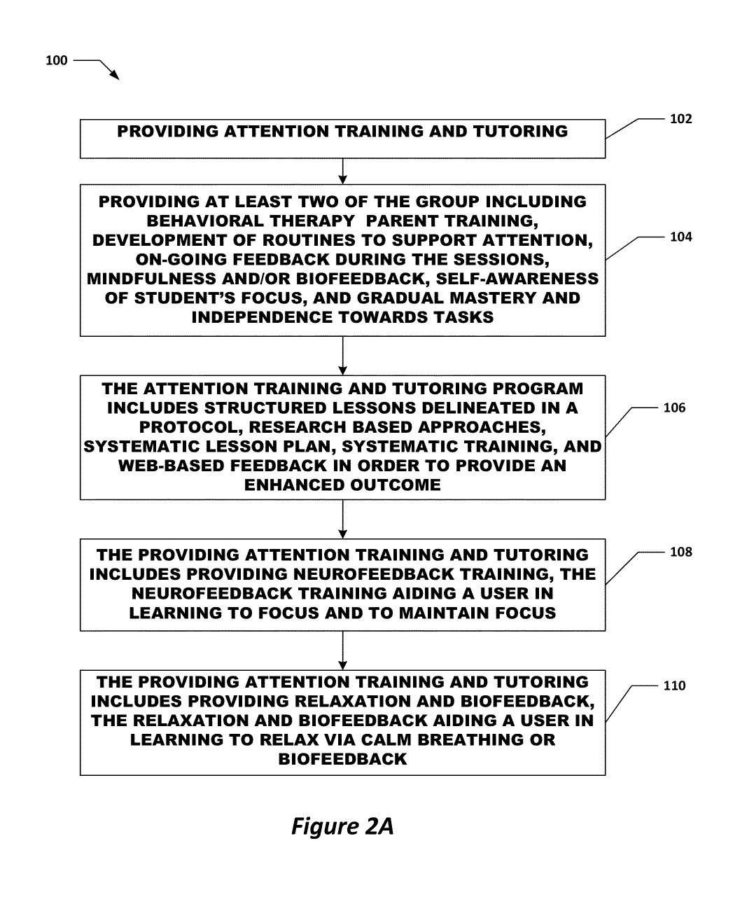

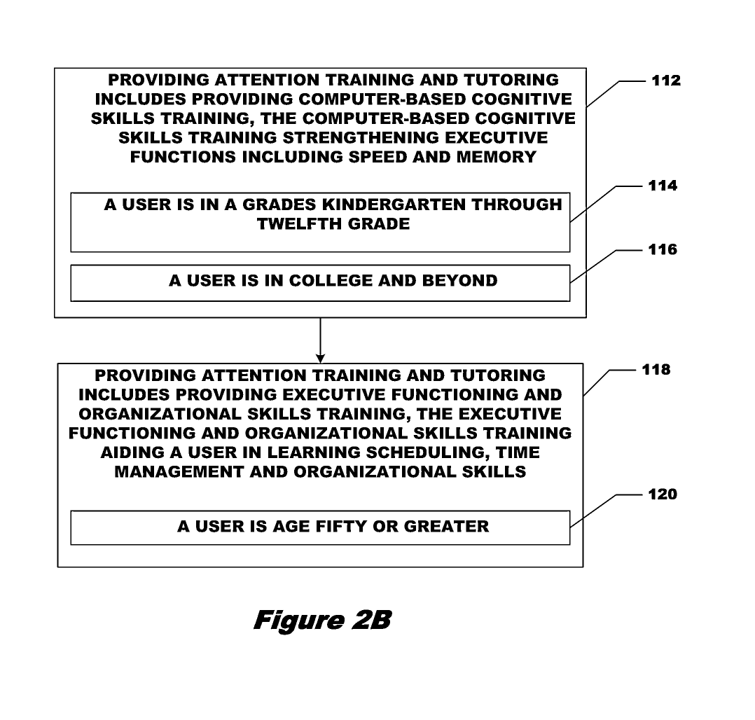

A flow chart of a particular embodiment of the presently disclosed method 100 is depicted in FIGS. 2A and 2B. The rectangular elements are herein denoted “processing blocks” and represent computer software instructions or groups of instructions. The flow diagrams do not depict the syntax of any particular programming language. Rather, the flow diagrams illustrate the functional information one of ordinary skill in the art requires to fabricate circuits or to generate computer software to perform the processing required in accordance with the present invention. It should be noted that many routine program elements, such as initialization of loops and variables and the use of temporary variables are not shown. It will be appreciated by those of ordinary skill in the art that unless otherwise indicated herein, the particular sequence of steps described is illustrative only and can be varied without departing from the spirit of the invention. Thus, unless otherwise stated the steps described below are unordered meaning that, when possible, the steps can be performed in any convenient or desirable order.

Method 100 begins with processing block 102 which discloses providing attention training and tutoring. Processing block 104 states providing at least two of the group including behavioral therapy, parent training, development of routines to support attention, on-going feedback during the sessions, mindfulness, relaxation and/or biofeedback, self-awareness of student's focus, and gradual mastery and independence towards tasks.

Processing block 106 recites the attention training and tutoring program includes structured lessons delineated in a protocol, research based approaches, systematic lesson plan, systematic training, on-going feedback, and web-based data tracking and review in order to provide an enhanced outcome.

Processing block 108 discloses the attention training and tutoring includes providing neurofeedback training, the neurofeedback training aiding a user in learning to focus and to maintain focus.

Processing block 110 states the attention training and tutoring includes providing relaxation and biofeedback, said relaxation and biofeedback aiding a user in learning to relax via calm breathing or biofeedback.

Processing continues on FIG. 2B with processing block 112 which recites the attention training and tutoring includes providing executive functioning and organizational skills training, the executive functioning and organizational skills training aiding a user in learning scheduling, time management and organizational skills. As shown in processing block 114, a user is in a grades kindergarten through twelfth grade. Alternately, as shown in processing block 116, a user is in college and beyond.

Processing block 118 discloses the providing attention training and tutoring includes computer-based cognitive skills training, said computer-based cognitive skills training strengthening cognition, and executive functions including speed and memory. As shown in processing block 120, a user is age fifty or greater.

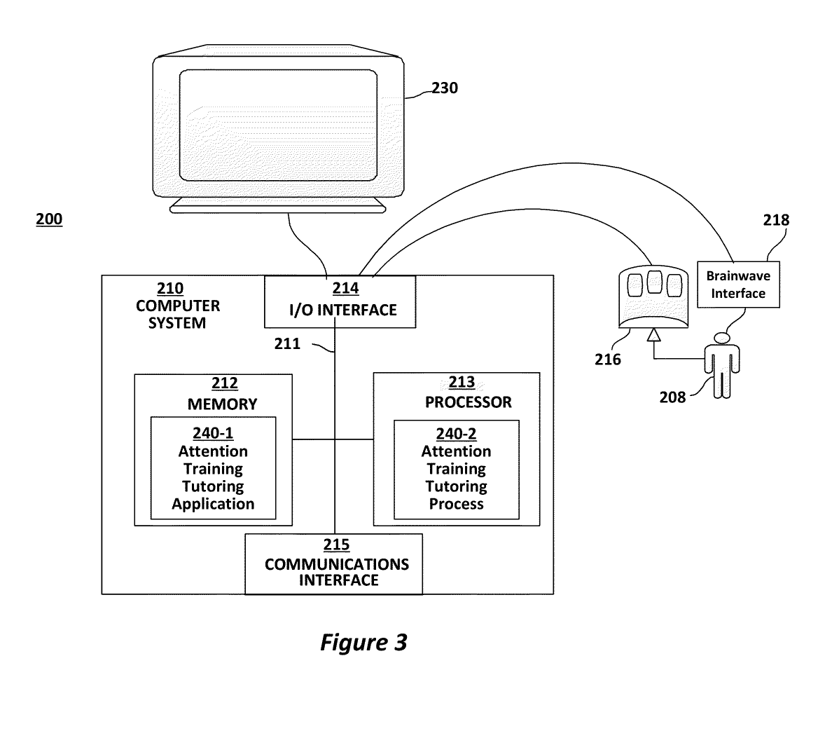

FIG. 3 is a block diagram illustrating example architecture of a computer system 210 that executes, runs, interprets, operates or otherwise performs an attention training and tutoring application 240-1 and attention training and tutoring process 240-2 suitable for use in explaining example configurations disclosed herein. The computer system 210 may be any type of computerized device such as a personal computer, workstation, portable computing device, console, laptop, network terminal or the like. An input device 216 (e.g., one or more customer/developer controlled devices such as a keyboard, mouse, etc.) couples to processor 213, as does the brainwave interface 218, through I/O interface 214. The brainwave interface 218 enables the measured brainwaves to be analyzed, and the input device 216 enables a user 208 to provide input commands, and generally control the graphical customer interface that the attention training and tutoring application 240-1 and process 240-2 provides on the display 230. As shown in this example, the computer system 210 includes an interconnection mechanism 211 such as a data bus or other circuitry that couples a memory system 212, a processor 213, an input/output interface 214, and a communications interface 215. The communications interface 215 enables the computer system 210 to communicate with other devices (i.e., other computers) on a network (not shown).

The memory system 212 is any type of computer readable medium, and in this example, is encoded with an attention training and tutoring application 240-1 as explained herein. The attention training and tutoring application 240-1 may be embodied as software code such as data and/or logic instructions (e.g., code stored in the memory or on another computer readable medium such as a removable disk) that supports processing functionality according to different embodiments described herein. During operation of the computer system 210, the processor 213 accesses the memory system 212 via the interconnect 211 in order to launch, run, execute, interpret or otherwise perform the logic instructions of an attention training and tutoring application 240-1. Execution of an attention training and tutoring application 240-1 in this manner produces processing functionality in the attention training and tutoring process 240-2. In other words, the attention training and tutoring process 240-2 represents one or more portions or runtime instances of a attention training and tutoring application 240-1 (or the entire a attention training and tutoring application 240-1) performing or executing within or upon the processor 213 in the computerized device 210 at runtime.

It is noted that example configurations disclosed herein include the attention training and tutoring application 240-1 itself (i.e., in the form of un-executed or non-performing logic instructions and/or data). The attention training and tutoring application 240-1 may be stored on a computer readable medium (such as a floppy disk), hard disk, electronic, magnetic, optical, or other computer readable medium. An attention training and tutoring application 240-1 may also be stored in a memory system 212 such as in firmware, read only memory (ROM), or, as in this example, as executable code in, for example, Random Access Memory (RAM). In addition to these embodiments, it should also be noted that other embodiments herein include the execution of an attention training and tutoring application 240-1 in the processor 213 as the attention training and tutoring process 240-2. Those skilled in the art will understand that the computer system 210 may include other processes and/or software and hardware components, such as an operating system not shown in this example.

During operation, processor 213 of computer system 200 accesses memory system 212 via the interconnect 211 in order to launch, run, execute, interpret or otherwise perform the logic instructions of the attention training and tutoring application 240-1. Execution of the attention training and tutoring application 240-1 produces processing functionality in attention training and tutoring process 240-2. In other words, the attention training and tutoring process 240-2 represents one or more portions of the attention training and tutoring application 240-1 (or the entire application) performing within or upon the processor 213 in the computer system 200.

It should be noted that, in addition to the attention training and tutoring process 240-2, embodiments herein include the attention training and tutoring application 240-1 itself (i.e., the un-executed or non-performing logic instructions and/or data). The attention training and tutoring application 240-1 can be stored on a computer readable medium such as a floppy disk, hard disk, or optical medium. The attention training and tutoring application 240-1 can also be stored in a memory type system such as in firmware, read only memory (ROM), or, as in this example, as executable code within the memory system 212 (e.g., within Random Access Memory or RAM).

In addition to these embodiments, it should also be noted that other embodiments herein include the execution of attention training and tutoring application 240-1 in processor 213 as the attention training and tutoring process 240-2. Those skilled in the art will understand that the computer system 200 can include other processes and/or software and hardware components, such as an operating system that controls allocation and use of hardware resources associated with the computer system 200.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s), laptop(s), handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet, as well as a virtual network. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun may be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

What is claimed is:

1. A method of providing an attention training and tutoring program comprising:
providing attention training and tutoring; and
providing at least two of the group including behavioral therapy, parent training, development of routines to support attention, on-going feedback during the sessions, mindfulness, relaxation and/or biofeedback, self-awareness of student's focus, and gradual mastery and independence towards tasks.

2. The method of claim 1 wherein said attention training and tutoring program includes structured lessons delineated in a protocol, research based approaches, systematic lesson plan, systematic training, formal questionnaires, and web-based data tracking and review in order to provide an enhanced outcome.

3. The method of claim 1 wherein said providing attention training and tutoring includes providing neurofeedback training, said neurofeedback training aiding a user in learning to focus and to maintain focus.

4. The method of claim 3 wherein said providing attention training and tutoring includes providing relaxation and biofeedback, said relaxation and biofeedback aiding a user in learning to relax via calm breathing or biofeedback.

5. The method of claim 4 wherein said providing attention training and tutoring includes providing executive functioning and organizational skills training, said executive functioning and organizational skills training aiding a user in learning scheduling, time management and organizational skills.

6. The method of claim 4 wherein said providing attention training and tutoring includes providing computer-based cognitive skills training, said computer-based cognitive skills training strengthening executive functions including speed and memory.

7. The method of claim 5 wherein a user is in a grades kindergarten through twelfth grade.

8. The method of claim 5 wherein a user is in college and beyond.

9. The method of claim 6 wherein a user is age fifty or greater.

10. A non-transitory computer readable storage medium having computer readable code thereon for providing attention training and tutoring, the medium including instructions in which a computer system performs operations comprising:
providing computer attention training; and
providing at least two of the group including behavioral therapy parent training, development of routines to support attention, on-going feedback during the sessions, mindfulness and/or biofeedback, self-awareness of student's focus, and gradual mastery and independence towards tasks.

11. The computer readable storage medium of claim 10 wherein said attention training and tutoring program includes structured lessons delineated in a protocol, research based approaches, systematic lesson plan, systematic training, formal questionnaires, and web-based data tracking and review in order to provide an enhanced outcome.

12. The computer readable storage medium of claim 10 wherein said providing attention training and tutoring includes providing neurofeedback training, said neurofeedback training aiding a user in learning to focus and to maintain focus.

13. The computer readable storage medium of claim 12 wherein said providing attention training and tutoring includes providing relaxation and biofeedback, said relaxation and biofeedback aiding a user in learning to relax via calm breathing or biofeedback.

14. The computer readable storage medium of claim 13 wherein said providing attention training and tutoring includes providing executive functioning and organizational skills training, said executive functioning and organizational skills training aiding a user in learning scheduling, time management and organizational skills.

15. The computer readable storage medium of claim 13 wherein said providing attention training and tutoring includes providing computer-based cognitive skills training, said computer-based cognitive skills training strengthening executive functions including speed and memory.

16. The computer readable storage medium of claim 14 wherein a user is in a grades kindergarten through twelfth grade.

17. The computer readable storage medium of claim 14 wherein a user is in college and beyond.

18. The computer readable storage medium of claim 15 wherein a user is age fifty or greater.

19. A computer system comprising:
a memory;
a processor;
a communications interface;
an interconnection mechanism coupling the memory, the processor and the communications interface; and
wherein the memory is encoded with an application providing attention training and tutoring, that when performed on the processor, provides a process for processing information, the process causing the computer system to perform the operations of:
providing computer attention and tutoring training;
providing at least two of the group including behavioral therapy, parent training, development of routines to support attention, on-going feedback during the sessions, mindfulness, relaxation and/or biofeedback, self-awareness of student's focus, and gradual mastery and independence towards tasks;
wherein said attention training and tutoring program includes structured lessons delineated in a protocol, research based approaches, systematic lesson plan, systematic training, formal questionnaires, and web-based data tracking and review in order to provide an enhanced outcome;
wherein said providing attention training and tutoring includes providing neurofeedback training, said neurofeedback training aiding a user in learning to focus and to maintain focus; and
wherein said providing attention training and tutoring includes providing relaxation and biofeedback, said relaxation and biofeedback aiding a user in learning to relax via calm breathing or biofeedback.

20. The computer system of claim 19 wherein said providing attention training and tutoring includes providing one of the group comprising:
executive functioning and organizational skills training, said executive functioning and organizational skills training aiding a user in learning scheduling, time management and organizational skills; and
computer-based cognitive skills training, said computer-based cognitive skills training strengthening cognition, and executive functions including speed and memory.
